(19) United States
(12) Patent Application Publication
(10) Pub. No.: US 2026/0296302 A1
(43) Pub. Date: Oct. 1, 2026

(54) INTERIOR LIGHT CONTROL APPARATUS AND METHOD OF CONTROLLING INTERIOR LIGHT

(71) Applicant: MITSUBISHI ELECTRIC MOBILITY CORPORATION, Tokyo (JP)

(72) Inventors: Yuki TAKEDA, Tokyo (JP); Hiroshi ONODERA, Tokyo (JP); Satoru INOUE, Tokyo (JP)

(73) Assignee: MITSUBISHI ELECTRIC MOBILITY CORPORATION, Tokyo (JP)

(21) Appl. No.: 19/480,439

(22) PCT Filed: Jun. 7, 2023
(86) PCT No.: PCT/JP2023/021096

§ 371 Date: Oct. 31, 2025

(51) Int. Cl. B60Q 3/18; B60Q 3/78; H05B 47/115; H05B 47/16

(52) U.S. Cl. CPC B60Q 3/18; B60Q 3/78; H05B 47/115; H05B 47/16; B60Q 2500/30

(57) ABSTRACT

The object is to provide a technology that can specifically notify a direction and a risk of an obstacle. An interior light control apparatus that controls an interior light of a vehicle includes: an obtainment unit to obtain obstacle information that is information on an obstacle around the vehicle; and a controller to determine a direction of the obstacle with respect to a driver of the vehicle and a risk of the obstacle, based on the obstacle information, and control lighting a portion corresponding to the direction with respect to the driver in an interior light, in a mode having noticeability for responding to the risk, the interior light being disposed to continuously or intermittently surround at least a front and a side of the driver in a top view.

### TECHNICAL FIELD

The present disclosure relates to an interior light control apparatus and a method of controlling an interior light.

### BACKGROUND ART

When an obstacle around a vehicle has been detected, known is a technology for notifying the obstacle to a driver of the vehicle by lighting the obstacle with a headlight or an auxiliary light (hereinafter, these will be collectively referred to as an “exterior light”). Under a bright environment around the vehicle, such as during the daytime with the sun, however, a problem arises in that the driver cannot confirm the exterior light itself. Thus, proposed is a technology for notifying an obstacle to a driver using not an exterior light but light sources disposed at both sides of an instrument panel inside a vehicle cabin (for example, Patent Document 1).

### PRIOR ART DOCUMENT

### Patent Document

[Patent Document 1] Japanese Patent Application Laid-Open No. 2014-10773

### SUMMARY

### Problem to be Solved by the Invention

Under the technology of Patent Document 1, however, only one of the light sources disposed at both sides is lit based on a direction of the obstacle with respect to the vehicle. Thus, problems arise in that the driver can roughly know the existing direction of the obstacle, and cannot specifically know the direction and a risk of the obstacle. As a result of this, the driver needs to search for the obstacle while paying regular attention when the light source is lit. Thus, there is a possibility that the driver may be delayed in responding to the obstacle.

The present disclosure has been made in view of the problems, and has an object of providing a technology that can specifically notify a direction and a risk of an obstacle.

### Means to Solve the Problem

An interior light control apparatus according to the present disclosure is an interior light control apparatus that controls an interior light of a vehicle and includes: an obtainment unit to obtain obstacle information that is information on an obstacle around the vehicle; and a controller to determine a direction of the obstacle with respect to a driver of the vehicle and a risk of the obstacle, based on the obstacle information, and control lighting a portion corresponding to the direction with respect to the driver in an interior light, in a mode having noticeability for responding to the risk, the interior light being disposed to continuously or intermittently surround at least a front and a side of the driver in a top view.

### Effects of the Invention

The present disclosure controls lighting a portion corresponding to the direction with respect to the driver in an interior light, in a mode having noticeability for responding to the risk, the interior light being disposed to continuously or intermittently surround at least a front or a side of the driver in a top view. Such a structure can specifically notify the direction and the risk of the obstacle.

The object, features, aspects, and advantages of the present disclosure will become more apparent from the following detailed description and the accompanying drawings.

### BRIEF DESCRIPTION OF DRAWINGS

FIG. 1 is a block diagram illustrating a configuration of an interior light control apparatus according to Embodiment 1.

FIG. 2 illustrates an example arrangement of an interior light according to Embodiment 1.

FIG. 3 is a top view illustrating the interior light control apparatus according to Embodiment 1.

FIG. 4 is a flowchart illustrating operations of the interior light control apparatus according to Embodiment 1.

FIG. 5 is a diagram illustrating an interior light control apparatus according to Embodiment 2.

FIG. 6 is a flowchart illustrating operations of the interior light control apparatus according to Embodiment 2.

FIG. 7 is a block diagram illustrating a configuration of an interior light control apparatus according to Embodiment 3.

FIG. 8 is a flowchart illustrating operations of the interior light control apparatus according to Embodiment 3.

FIG. 9 is a flowchart illustrating operations of the interior light control apparatus according to Embodiment 4.

FIG. 10 is a block diagram illustrating a hardware configuration of an interior light control apparatus according to other modifications.

FIG. 11 is a block diagram illustrating a hardware configuration of the interior light control apparatus according to other modifications.

### DESCRIPTION OF EMBODIMENTS

### Embodiment 1

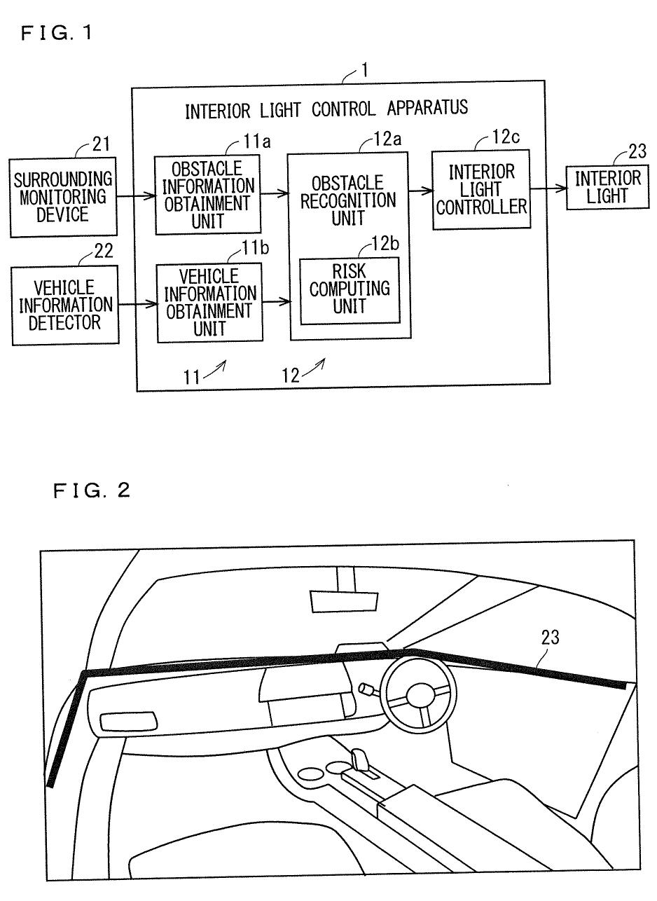

FIG. 1 is a block diagram illustrating a configuration of an interior light control apparatus 1 according to Embodiment 1. While the interior light control apparatus 1 according to Embodiment 1 is disposed in a vehicle to be a controlled target of the interior light control apparatus 1, which is not limited to this, for example, the interior light control apparatus 1 may be disposed in a server that can perform radio communication with the vehicle.

The interior light control apparatus 1 in FIG. 1 is communicatively connected to a surrounding monitoring device 21, a vehicle information detector 22, and an interior light 23 in the vehicle, and can control the interior light 23. Before describing the interior light control apparatus 1, the surrounding monitoring device 21, the vehicle information detector 22, and the interior light 23 will be described.

The surrounding monitoring device 21 detects surrounding information on a vehicle. The surrounding information includes obstacle information that is information on an obstacle around a vehicle. The obstacle information includes, for example, a direction of an obstacle with respect to a vehicle, and a distance to the vehicle. Furthermore, the obstacle information may include the size of an obstacle. Examples of an obstacle include at least one of a person, another vehicle, or a fallen object. Examples of the surrounding monitoring device 21 include at least one of a distance sensor such as a sonar, the radar, or the Light Detection and Ranging (LiDAR), or a camera capturing an image around a vehicle. In this Description, at least one of A, B, C, . . . , or Z means any one of all combinations obtained by combining one type or more extracted from each of groups of A, B, C, . . . , and Z.

The vehicle information detector 22 detects vehicle information on traveling of a vehicle, such as a steering wheel angle or a vehicle speed of the vehicle. The vehicle information detector 22 includes, for example, various sensors of the vehicle.

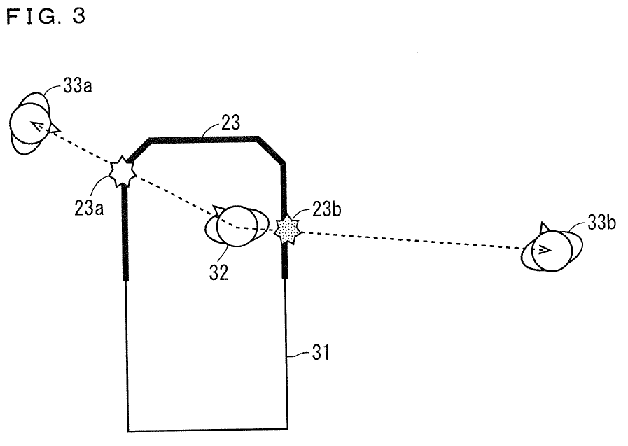

FIG. 2 illustrates a vehicle cabin when the front is viewed from the vicinity of the passenger seat of a vehicle 31. FIG. 3 is a top view schematically illustrating the vehicle 31. As illustrated in FIGS. 2 and 3, the interior light 23 is continuously or intermittently disposed to surround at least the front and the sides (e.g., the right and left) of a driver 32 of the vehicle 31 in a top view. The interior light 23 surrounding the driver 32 means that the interior light 23 is provided in an area larger than that of an instrument panel. Examples of the interior light 23 surrounding the driver 32 may include the interior light 23 surrounding the front, the left side, and the right side of the driver 32 as illustrated in FIG. 3, and the interior light 23 surrounding the front, the left side, the right side, and the rear of the driver 32.

The interior light 23 in FIGS. 2 and 3 has a line shape, and can simultaneously light a plurality of portions in the line shape. The interior light 23 may include a plurality of LED arrays that are aligned as a plurality of segments in the line shape and are freely and separately dimmable, or may be a LED light chain including a plurality of LEDs freely and separately dimmable.

While the interior light 23 in FIGS. 2 and 3 is a single continuous light, the interior light 23 may be a plurality of divided lights. The interior light 23 may be, for example, a light for making the cabin of the vehicle 31 brighter, a light for enhancing aesthetics in the cabin such as an ambient light and an illumination light, or a display device that can display information such as a liquid crystal panel and an organic EL.

In Embodiment 1, a region in which the interior light 23 is disposed includes a region corresponding to a blind spot of the driver 32. The region corresponding to a blind spot includes, for example, a region that is the closest to the blind spot. The blind spot is a region that the driver 32 cannot see outside the vehicle 31 from the driver seat, and examples of the blind spot include at least one of a region of A-pillars of the vehicle 31, a region of the hood, or a region of another structure.

Next, a structure of the interior light control apparatus 1 will be described. The interior light control apparatus 1 in FIG. 1 includes an obstacle information obtainment unit 11a, a vehicle information obtainment unit 11b, an obstacle recognition unit 12a including a risk computing unit 12b, and an interior light controller 12c. The obstacle information obtainment unit 11a and the vehicle information obtainment unit 11b are included in the concept of the obtainment unit 11, and the obstacle recognition unit 12a and the interior light controller 12c are included in the concept of the controller 12.

The obstacle information obtainment unit 11a obtains obstacle information from the surrounding information detected by the surrounding monitoring device 21. The obstacle information obtainment unit 11a may be an interface of the surrounding monitoring device 21, or the surrounding monitoring device 21 itself.

The vehicle information obtainment unit 11b obtains vehicle information detected by the vehicle information detector 22. The vehicle information obtainment unit 11b may be an interface of the vehicle information detector 22, or the vehicle information detector 22 itself.

The obstacle recognition unit 12a determines a direction of an obstacle with respect to the driver 32 and a risk of the obstacle, based on the obstacle information obtained by the obstacle information obtainment unit 11a and the vehicle information obtained by the vehicle information obtainment unit 11b.

For example, when the obstacle information includes the direction of the obstacle with respect to the vehicle 31, the obstacle recognition unit 12a may use the direction included in the obstacle information as a direction of the obstacle with respect to the driver 32. For example, when the obstacle information includes the direction of the obstacle and a distance to the obstacle with respect to the vehicle 31, the obstacle recognition unit 12a may calculate a direction of the obstacle with respect to the driver 32, based on the direction and the distance included in the obstacle information. The direction of the obstacle with respect to the driver 32 may be a direction with respect to a driver seat.

The risk computing unit 12b of the obstacle recognition unit 12a determines, for example, a distance and a type of an obstacle based on the obstacle information and the vehicle information, and determines a risk indicating the probability that the vehicle 31 collides with the obstacle. For example, the risk computing unit 12b increases the risk as the distance is shorter, and increases the risk when the type is person more than that when the type is fallen object.

The obstacle recognition unit 12a according to Embodiment 1 determines a direction and a risk using both of the obstacle information and the vehicle information to increase the accuracy of the direction and the risk. However, when the accuracy of the direction and the risk need not be increased, the obstacle recognition unit 12a may determine a direction and a risk using the obstacle information without using the vehicle information. Here, the vehicle information obtainment unit 11b is not essential. Furthermore, the obstacle recognition unit 12a may determine a direction and a risk using numerical information of the obstacle information as it is, or determine a direction and a risk by performing the mapping based on the obstacle information.

The interior light controller 12c controls lighting the interior light 23, based on the direction and the risk determined by the obstacle recognition unit 12a. Specifically, the interior light controller 12c controls lighting a portion corresponding to the direction determined by the obstacle recognition unit 12a with respect to the driver 32 in the interior light 23, in a mode having noticeability for responding to the risk determined by the obstacle recognition unit 12a. In the following description, the portion corresponding to the direction with respect to the driver 32 in the interior light 23 may be referred to as an “obstacle responding portion”.

The obstacle responding portion includes at least one of a portion of the interior light 23 which is located in the direction determined by the obstacle recognition unit 12a with respect to the driver 32, or its surrounding portion. The portion corresponding to the direction with respect to the driver 32 in the interior light 23 may be a portion corresponding to the direction with respect to a driver seat in the interior light 23.

The interior light controller 12c lights the obstacle responding portion of the interior light 23 in a mode having higher noticeability as the risk is higher, as the mode having noticeability for responding to the risk. The modes having higher noticeability include at least one of a mode of making the obstacle responding portion brighter, a mode of increasing an area (e.g., a width) of the obstacle responding portion, a mode of changing the color of the obstacle responding portion into a warning color (e.g., red), or a mode of shortening a blinking period when the obstacle responding portion blinks. The modes having higher noticeability are not limited to these as long as the obstacle responding portion is in a noticeable mode.

The obstacle recognition unit 12a and the interior light controller 12c will be described with reference to FIG. 3. Pedestrians 33a and 33b that are obstacles exist around the vehicle 31 in FIG. 3. Here, the obstacle recognition unit 12a determines directions of the pedestrians 33a and 33b with respect to the driver 32, and risks of the pedestrians 33a and 33b. Since a distance between the pedestrian 33a and the vehicle 31 is shorter than a distance between the pedestrian 33b and the vehicle 31, the obstacle recognition unit 12a sets the risk of the pedestrian 33a higher than that of the pedestrian 33b.

The interior light controller 12c controls lighting an obstacle responding portion 23a corresponding to a direction from the driver 32 to the pedestrian 33a in the interior light 23, in a mode having higher noticeability for responding to a higher risk. Furthermore, the interior light controller 12c controls lighting an obstacle responding portion 23b corresponding to a direction from the driver 32 to the pedestrian 33b in the interior light 23, in a mode having lower noticeability for responding to a lower risk. Consequently, the obstacle responding portion 23a is lit in a mode more noticeable than that of the obstacle responding portion 23b, by differing in at least one of brightness, area, color, or blinking period from the obstacle responding portion 23b.

### <Operations>

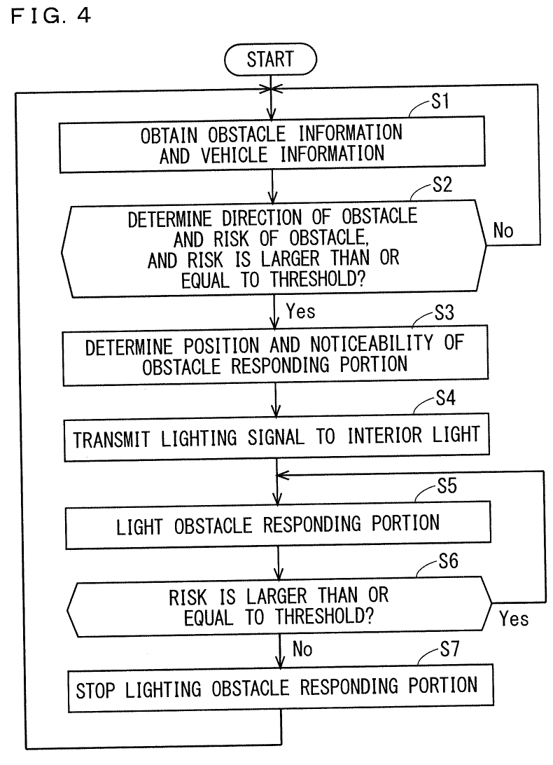

FIG. 4 is a flowchart illustrating operations of the interior light control apparatus 1 according to Embodiment 1. The operations in FIG. 4 are repeatedly performed while a key switch of the vehicle 31 is turned on or power is supplied to the interior light control apparatus 1. Furthermore, when the number of obstacles is multiple, the operations that will be described below are performed for each of the obstacles.

In Step S1, the obstacle information obtainment unit 11a obtains obstacle information, and the vehicle information obtainment unit 11b obtains vehicle information.

In Step S2, the obstacle recognition unit 12a determines a direction of an obstacle with respect to the driver 32, and a risk of the obstacle, based on the obstacle information and the vehicle information, and determines whether the risk is larger than or equal to a predefined threshold. When it is determined that the risk is larger than or equal to the threshold, the processes proceed to Step S3. When it is determined that the risk is smaller than the threshold, the processes return to Step S1.

In Step S3, the interior light controller 12c determines a position and noticeability of an obstacle responding portion, based on the direction and the risk determined by the obstacle recognition unit 12a.

In Step S4, the interior light controller 12c transmits a lighting signal indicating the position and the noticeability of the obstacle responding portion to the interior light 23.

In Step S5, the interior light 23 lights the obstacle responding portion at the position indicated by the lighting signal, in a mode having the noticeability indicated by the lighting signal.

In Step S6, the obstacle recognition unit 12a determines whether the risk is larger than or equal to a threshold by performing the processes identical to Step S1 and Step S2. When it is determined that the risk is larger than or equal to the threshold, the processes return to Step S5. When it is determined that the risk is smaller than the threshold, the processes proceed to Step S7.

In Step S7, the interior light controller 12c stops lighting the obstacle responding portion in the aforementioned mode. Then, the processes return to Step S1.

### Summary of Embodiment 1

The aforementioned interior light control apparatus 1 according to Embodiment 1 lights a portion corresponding to a direction from the driver 32 to an obstacle in the interior light 23, in a mode having noticeability for responding to the risk. Such a structure allows the driver to specifically know the direction and the risk of the obstacle. Consequently, for example, the driver can easily search for the obstacle, and promptly respond to the obstacle.

In Embodiment 1, a region in which the interior light 23 is disposed includes a region corresponding to a blind spot of a driver. Since such a structure allows the driver to confirm the existence of an obstacle even when the obstacle is located in a blind spot made by, for example, A-pillars, the driver can cautiously drive.

### Embodiment 2

A block diagram illustrating a configuration of the interior light control apparatus 1 according to Embodiment 2 is identical to that in FIG. 1 described in Embodiment 1. Hereinafter, constituent elements according to Embodiment 2 identical or similar to those described above will be denoted by the same or similar reference numerals, and the different constituent elements will be mainly described.

In Embodiment 1, the noticeability of the obstacle responding portion is maintained, irrespective of an elapsed time since lighting of the obstacle responding portion of the interior light 23. In contrast, the interior light controller 12c of Embodiment 2 is configured to reduce the noticeability of the obstacle responding portion of the interior light 23 with the passage of time since lighting of the obstacle responding portion.

For example, the interior light controller 12c may urge the driver to confirm the existence of an obstacle by relatively increasing the area (e.g., width) of the obstacle responding portion to guide the gaze of the driver at the beginning of lighting of the obstacle responding portion. Then, the interior light controller 12c may reduce the noticeability of the obstacle responding portion of the interior light 23 by reducing the area of the obstacle responding portion with the passage of time since lighting of the obstacle responding portion. Such a structure can light obstacle responding portions for two obstacles with spacing, even when a distance between the two obstacles is short in a driver's view.

For example, the interior light controller 12c may urge the driver to confirm the existence of an obstacle by relatively increasing the brightness of the obstacle responding portion to guide the gaze of the driver at the beginning of lighting of the obstacle responding portion. Then, the interior light controller 12c may reduce the noticeability of the obstacle responding portion by darkening the obstacle responding portion with the passage of time since lighting of the obstacle responding portion of the interior light 23. Since such a structure can suppress dazzling the driver which is caused by the backlight of the obstacle responding portion at nighttime, the driver can easily confirm an obstacle.

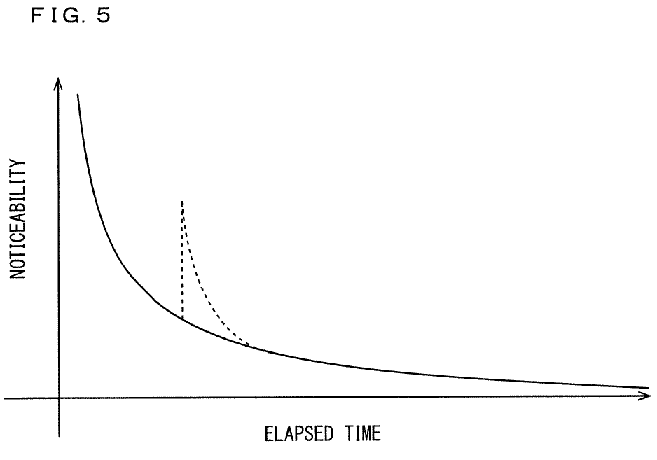

The interior light controller 12c need not linearly change the noticeability of the obstacle responding portion with respect to an elapsed time of lighting. For example, as indicated by the solid line in FIG. 5, the interior light controller 12c may logarithmically change the noticeability of the obstacle responding portion with respect to an elapsed time of lighting. For example, the interior light controller 12c may instantaneously increase the noticeability of the obstacle responding portion, when generally reducing the noticeability of the obstacle responding portion as the elapsed time of lighting increases. In other words, as indicated by the solid line and the dotted line in FIG. 5, the interior light controller 12c may change the noticeability of the obstacle responding portion discontinuously in time, for example, reduce the noticeability by 30% and then increase the noticeability to 60%. In this case, the driver's attention can be attracted to an obstacle. Furthermore, the interior light controller 12c may change the noticeability not as indicated by the solid line and the dotted line in FIG. 5 with time but change the noticeability stepwise with time.

The interior light controller 12c may be configured to reduce the noticeability of the obstacle responding portion as the risk is lower. In such a structure, when a plurality of obstacles are present, the driver can preferentially respond to an obstacle whose obstacle responding portion has higher noticeability and whose risk is higher. When the risk of an obstacle is a certain value or more, the interior light controller 12c may prohibit reducing the obstacle responding portion for the obstacle.

### <Operations>

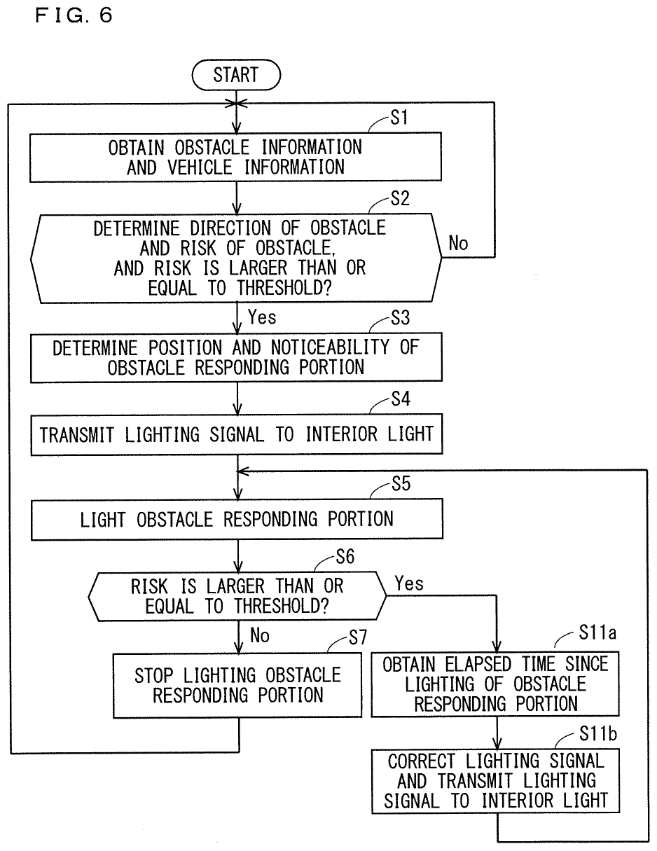

FIG. 6 is a flowchart illustrating operations of the interior light control apparatus 1 according to Embodiment 2. The operations in FIG. 6 are identical to a structure obtained by adding a noticeability changing process including Steps S11a and S11b to the operations in FIG. 4. Thus, Steps S11a and S11b will be mainly described hereinafter.

When it is determined that the risk is larger than or equal to the threshold in Step S6, the processes proceed to Step S11a. When it is determined that the risk is smaller than the threshold in Step S6, the processes proceed to Step S7.

In Step S11a, the interior light controller 12c obtains an elapsed time since lighting in Step S5.

In Step S11b, the interior light controller 12c checks the obtained time with the logarithmic curve in, for example, FIG. 5 to determine attenuation of the noticeability. Then, the interior light controller 12c corrects a lighting signal such that the noticeability is reduced by the obtained attenuation and transmits the corrected lighting signal to the interior light 23. Then, the processes proceed to Step S5. This reduces the noticeability of a lighting mode for the obstacle responding portion in Step S5.

### <Summary of Embodiment 2>

The aforementioned interior light control apparatus 1 according to Embodiment 2 reduces the noticeability of the obstacle responding portion with the passage of time since lighting of the obstacle responding portion of the interior light 23. Such a structure allows the obstacle responding portion to be appropriately lit.

### Embodiment 3

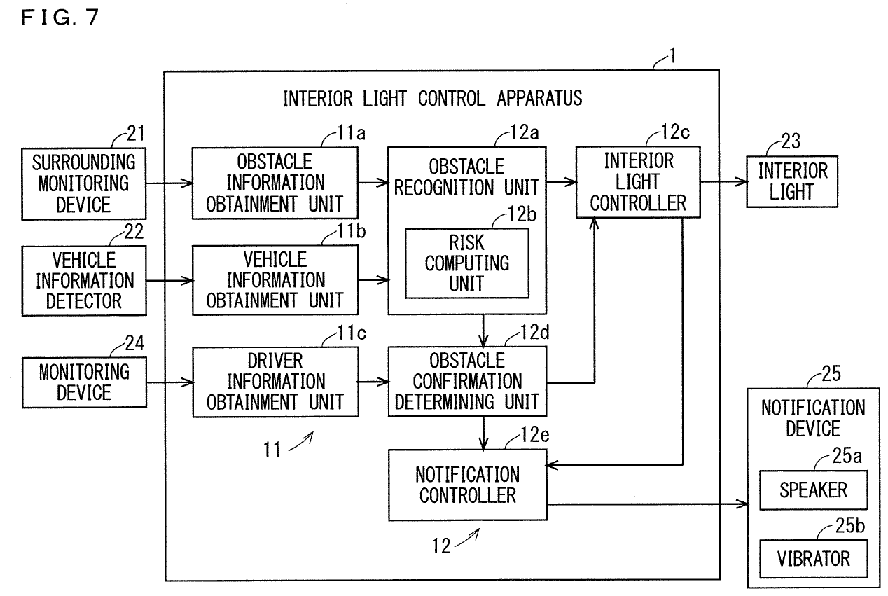

FIG. 7 is a block diagram illustrating a configuration of the interior light control apparatus 1 according to Embodiment 3. Hereinafter, constituent elements according to Embodiment 3 identical or similar to those described above will be denoted by the same or similar reference numerals, and the different constituent elements will be mainly described.

The interior light control apparatus 1 in FIG. 7 is communicatively connected to a monitoring device 24 and a notification device 25. The monitoring device 24 is, for example, a driver monitoring system (DMS), and detects a state of the driver and generates driver information that is information indicating the state of the driver.

The notification device 25 includes a speaker 25a that can notify the driver by voice, and a vibrator 25b that can notify the driver by vibrations. The notification device 25 is not limited to this but may be any device that can notify, for example, human senses, and may include at least one of, for example, the speaker 25a, the vibrator 25b, or a display that can notify the driver through display.

The configuration of the interior light control apparatus 1 in FIG. 7 is identical to a configuration obtained by adding a driver information obtainment unit 11c, an obstacle confirmation determining unit 12d, and a notification controller 12e to the configuration of the interior light control apparatus 1 in FIG. 1. The driver information obtainment unit 11c is included in the concept of the obtainment unit 11, and the obstacle confirmation determining unit 12d and the notification controller 12e are included in the concept of the controller 12.

The driver information obtainment unit 11c obtains driver information generated by the monitoring device 24. The driver information obtainment unit 11c may be an interface of the monitoring device 24, or the monitoring device 24 itself.

The obstacle confirmation determining unit 12d determines whether the driver has confirmed an obstacle, based on the driver information obtained by the driver information obtainment unit 11c, and a direction of the obstacle with respect to the driver 32 which has been determined by the obstacle recognition unit 12a. For example, the obstacle confirmation determining unit 12d determines the gaze of the driver based on the driver information, and determines whether the driver has confirmed an obstacle, based on whether a direction of the gaze is substantially identical to the direction of the obstacle with respect to the driver 32.

When the obstacle confirmation determining unit 12d determines that the driver has confirmed an obstacle, the interior light controller 12c reduces the noticeability of the obstacle responding portion for the obstacle determined that the confirmation has been made.

Even after a lapse of a predefined time since lighting of the obstacle responding portion of the interior light 23, when the obstacle confirmation determining unit 12d determines that the driver does not confirm an obstacle, the notification controller 12e. controls causing the notification device 25 to notify the driver.

### <Operations>

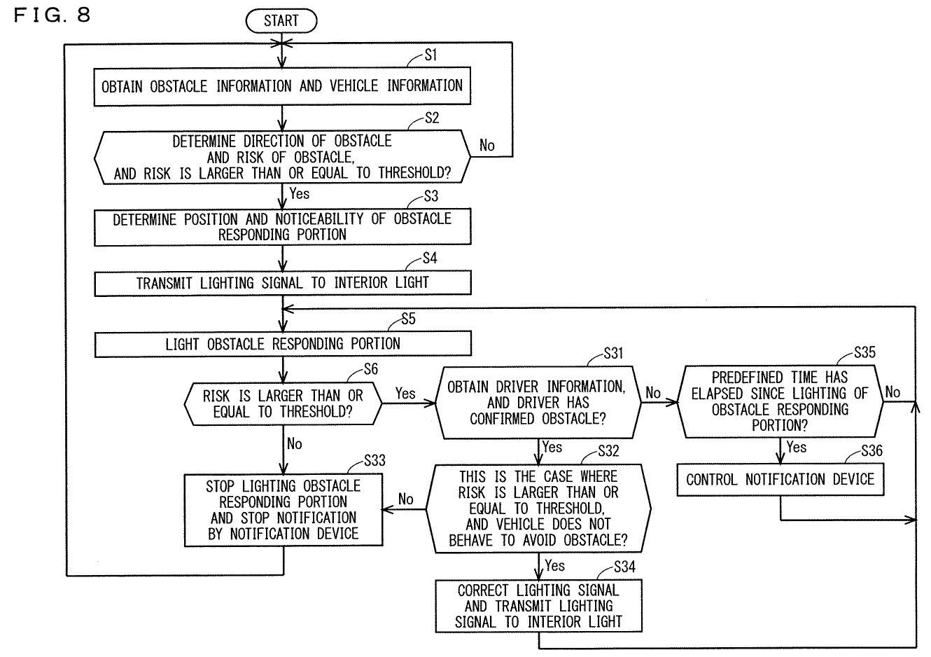

FIG. 8 is a flowchart illustrating operations of the interior light control apparatus 1 according to Embodiment 3. The operations in FIG. 8 are identical to a structure obtained by deleting Step S7 from the operations in FIG. 4 and adding Steps S31 to S36. Thus, Steps S31 to S36 will be mainly described hereinafter.

When it is determined that the risk is larger than or equal to the threshold in Step S6, the processes proceed to Step S31. When it is determined that the risk is smaller than the threshold in Step S6, the processes proceed to Step S33.

In Step S31, the driver information obtainment unit 11c obtains driver information. Then, the obstacle confirmation determining unit 12d determines whether the driver has confirmed an obstacle, based on the driver information obtained by the driver information obtainment unit 11c, and a direction of the obstacle with respect to the driver 32 which has been determined by the obstacle recognition unit 12a. When it is determined that the driver has confirmed an obstacle, the processes proceed to Step S32. When it is determined that the driver does not confirm an obstacle, the processes proceed to Step S35.

In Step S32, the obstacle recognition unit 12a determines whether the risk is larger than or equal to a threshold by performing the processes identical to Step S1 and Step S2. Furthermore, the obstacle recognition unit 12a determines whether the vehicle has behaved to avoid an obstacle, based on the obstacle information and the vehicle information. When it is determined that the risk is larger than or equal to the threshold and the vehicle does not behave to avoid an obstacle, the processes proceed to Step S34. Otherwise, the processes proceed to Step S33.

When the processes proceed to Step S33, it is determined in Step S32 that the risk is smaller than the threshold or the vehicle has behaved to avoid an obstacle. Thus, in Step S33, the interior light controller 12c stops lighting the obstacle responding portion in the aforementioned mode. The notification controller 12e stops notification by the notification device 25. Then, the processes return to Step S1.

When the processes proceed to Step S34, it is determined in Step S31 that the driver has tentatively confirmed the obstacle. Thus, in Step S34, the interior light controller 12c corrects a lighting signal such that the noticeability of the obstacle responding portion for the obstacle determined that confirmation has been made is reduced, and transmits the lighting signal to the interior light 23. Then, the processes return to Step S5.

In Step S35, the notification controller 12e determines whether a predefined time has elapsed since lighting of the obstacle responding portion of the interior light 23. When it is determined that the predefined time has elapsed, the processes proceed to Step S36. When it is determined that the predefined time does not elapse, the processes return to Step S5.

In Step S36, the notification controller 12e controls causing the notification device 25 to notify the driver. Here, the interior light controller 12c may correct a lighting signal such that the noticeability of the obstacle responding portion for the obstacle which the obstacle confirmation determining unit 12d determines that the driver does not confirm is increased, and transmit the lighting signal to the interior light 23. Then, the processes return to Step S5.

### <Summary of Embodiment 3>

When determining that the driver has confirmed an obstacle, the interior light control apparatus 1 according to Embodiment 3 reduces the noticeability of the obstacle responding portion for the obstacle determined that the confirmation has been made. Since the noticeability of the obstacle responding portion for the obstacle which the driver does not confirm is maintained in such a structure, it is possible to urge the driver to confirm such an obstacle.

In Embodiment 3, even after a lapse of a predefined time since lighting of the obstacle responding portion, when it is determined that the driver does not confirm an obstacle, control of causing the notification device 25 to notify the driver is performed. Such a structure can urge the driver to confirm an obstacle.

### <Modifications>

The monitoring device 24 need not be provided in Embodiment 3, which is not illustrated. Even after a lapse of a predefined time since lighting of the obstacle responding portion in such a structure, when the risk of the obstacle does not decrease, the notification controller 12e may control causing the notification device 25 to notify the driver. Such a structure can urge the driver to confirm an obstacle.

The notification device 25 may include an exterior light of a vehicle, which is not illustrated. Since such a structure can enhance lighting an obstacle, it is possible to notify both the driver and a person as an obstacle of a risky state and a position relationship between the vehicle and the person as the obstacle. The notification device 25 may include an instrument panel with a notification function, which is not illustrated.

### Embodiment 4

A block diagram illustrating a configuration of the interior light control apparatus 1 according to Embodiment 4 is identical to that in FIG. 1 described in Embodiment 1. Hereinafter, constituent elements according to Embodiment 4 identical or similar to those described above will be denoted by the same or similar reference numerals, and the different constituent elements will be mainly described.

The interior light controller 12c according to Embodiment 4 is configured to control a discontinuous change in a mode of the obstacle responding portion of the interior light 23 when at least one of the direction or the risk of the obstacle with respect to the driver is continuously changed. For example, the interior light controller 12c performs control such as changing a blinking period of the obstacle responding portion or changing a color of the light as control of the discontinuous change in the mode of the obstacle responding portion of the interior light 23.

### <Operations>

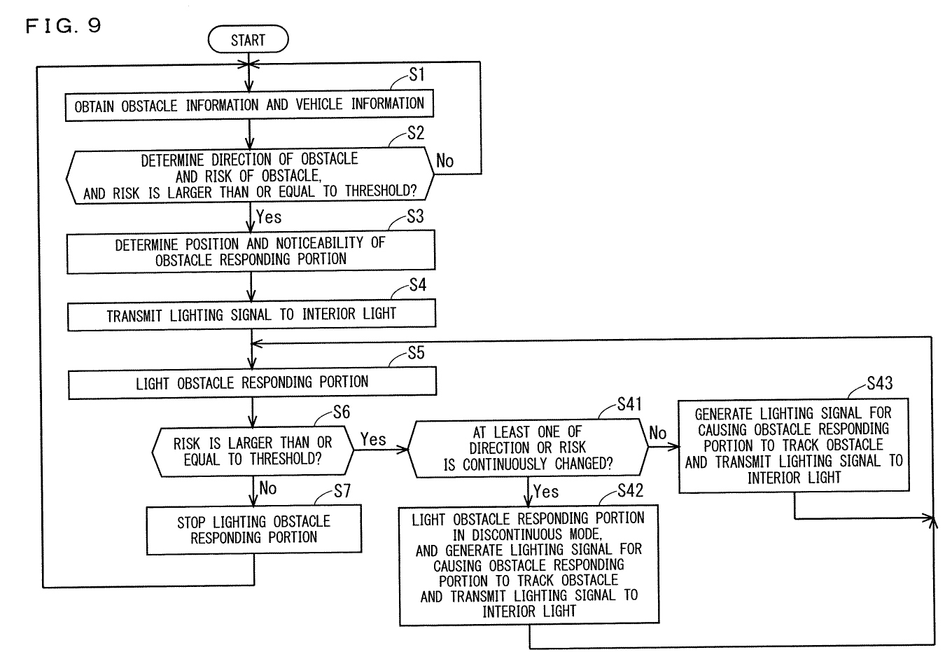

FIG. 9 is a flowchart illustrating operations of the interior light control apparatus 1 according to Embodiment 4. The operations in FIG. 9 are identical to a structure obtained by adding Steps S41 and S42 to the operations in FIG. 4. Thus, Steps S41 and S42 will be mainly described hereinafter.

When it is determined that the risk is larger than or equal to the threshold in Step S6, the processes proceed to Step S41. When it is determined that the risk is smaller than the threshold in Step S6, the processes proceed to Step S7.

In Step S41, the interior light controller 12c determines whether at least one of the direction or the risk of the obstacle is continuously changed, based on the direction and the risk of the obstacle determined in Step S2 and the direction and the risk of the obstacle used for the determination in Step S6. When it is determined that at least one of the direction or the risk of the obstacle is continuously changed, the processes proceed to Step S42. Otherwise, the processes proceed to Step S43.

In Step S42, the interior light controller 12c lights, in a discontinuous mode, the obstacle responding portion for the obstacle for which the determination has been made, and generates a lighting signal for causing the obstacle responding portion to track the obstacle and transmits the lighting signal to the interior light 23. Then, the processes return to Step S5.

In Step S43, the interior light controller 12c generates the lighting signal for causing the obstacle responding portion to track the obstacle for the obstacle for which the determination is not made, and transmits the lighting signal to the interior light 23. Then, the processes return to Step S5.

### <Summary of Embodiment 4>

When at least one of a direction or a risk of a pedestrian as an obstacle is continuously changed, in a structure of causing the obstacle responding portion to smoothly track the pedestrian and lighting the obstacle responding portion in a continuous mode, the driver cannot easily recognize, for example, the movement of an obstacle with a small change due to human characteristics.

Thus, the interior light control apparatus 1 according to Embodiment 4 controls a discontinuous change in a mode of the obstacle responding portion of the interior light 23 when at least one of the direction or the risk of the obstacle with respect to the driver is continuously changed. Since a change in a mode of the obstacle responding portion is large in such a structure, the driver can easily recognize, for example, the movement of an obstacle with a small change. Thereby, the driver can promptly recognize a risk given by an obstacle that changes from moment to moment.

### <Other Modifications>

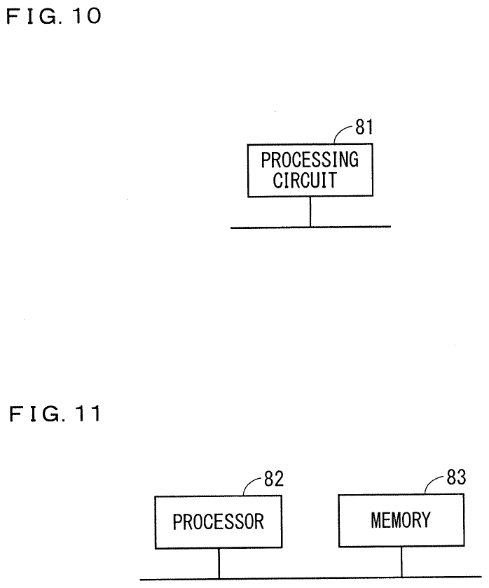

The aforementioned obtainment unit 11 and controller 12 in FIG. 1 will be referred to as the “obtainment unit 11, etc”. A processing circuit 81 in FIG. 10 implements the obtainment unit 11, etc. In other words, the processing circuit 81 includes: the obtainment unit 11 to obtain obstacle information that is information on an obstacle around the vehicle; and the controller 12 to determine a direction of the obstacle with respect to a driver of the vehicle and a risk of the obstacle, based on the obstacle information, and control lighting a portion corresponding to the direction with respect to the driver in an interior light, in a mode having noticeability for responding to the risk, the interior light being disposed to continuously or intermittently surround at least a front and a side of the driver in a top view. The processing circuit 81 may be dedicated hardware, or a processor that executes a program stored in a memory. The processor is, for example, a central processing unit, a processing unit, an arithmetic unit, a microprocessor, a microcomputer, or a digital signal processor (DSP).

When the processing circuit 81 is dedicated hardware, the processing circuit 81 is, for example, a single circuit, a composite circuit, a programmed processor, a parallel-programmed processor, an application-specific integrated circuit (ASIC), a field-programmable gate array (FPGA), or any combination of these. Each function of the units such as the obtainment unit 11, etc., may be implemented by distributed processing circuits, or the functions of the units may be collectively implemented by a single processing circuit.

When the processing circuit 81 is a processor, the functions of the obtainment unit 11, etc., are implemented by any combinations with software, etc. The software, etc., are for example, software, firmware, or the software and the firmware. The software, etc., are described as a program, and stored in a memory. As illustrated in FIG. 11, a processor 82 to be applied as the processing circuit 81 implements the functions of each of the units by reading and executing a program stored in a memory 83. In other words, the interior light control apparatus 1 includes the memory 83 to store a program which, when executed by the processing circuit 81, consequently executes steps of: obtaining obstacle information that is information on an obstacle around the vehicle; and determining a direction of the obstacle with respect to a driver of the vehicle and a risk of the obstacle, based on the obstacle information, and controlling lighting a portion corresponding to the direction with respect to the driver in an interior light, in a mode having noticeability for responding to the risk, the interior light being disposed to continuously or intermittently surround at least a front and a side of the driver in a top view. Put it differently, this program causes a computer to execute procedures or methods of the obtainment unit 11, etc. Here, examples of the memory 83 may include non-volatile or volatile semiconductor memories such as a random access memory (RAM), a read-only memory (ROM), a flash memory, an erasable programmable read-only memory (EPROM), an electrically erasable programmable read-only memory (EEPROM), a hard disk drive (HDD), a magnetic disk, a flexible disk, an optical disk, a compact disk, a mini disk, a digital versatile disc (DVD), a drive device thereof, and further any storage medium to be used in the future.

The configuration for implementing the functions of the obtainment unit 11, etc., using one of the hardware and the software, etc., is described above. However, the configuration is not limited to this but a part of the obtainment unit 11, etc., may be implemented by dedicated hardware, and another part thereof may be implemented by software, etc. For example, the processing circuit 81 functioning as the dedicated hardware can implement the functions of the obtainment unit 11, etc., and the processing circuit 81 functioning as the processor 82 can implement the functions of the others through reading and executing a program stored in the memory 83.

As described above, the processing circuit 81 can implement each of the functions by hardware, software, etc. or any combination of these.

Embodiments and the modifications can be freely combined, or appropriately modified and omitted.

The foregoing description is in all aspects illustrative and is not restrictive. It is understood that numerous modifications that have not yet been exemplified can be devised.

### EXPLANATION OF REFERENCE SIGNS

1 interior light control apparatus, 11 obtainment unit, 12 controller, 23 interior light, 23a, 23b obstacle responding portion, 25 notification device, 31 vehicle, 32 driver, 33a, 33b pedestrian.

1. An interior light control apparatus that controls an interior light of a vehicle, the interior light control apparatus comprising:
obtainment circuitry to obtain obstacle information that is information on an obstacle around the vehicle, and driver information that is information indicating a state of a driver; and
a controller to determine a direction of the obstacle with respect to the driver of the vehicle and a risk of the obstacle, based on the obstacle information, and control lighting a portion corresponding to the direction with respect to the driver in an interior light, in a mode having noticeability for responding to the risk, the interior light being disposed to continuously or intermittently surround at least a front and a side of the driver in a top view.
wherein the controller controls continuously or discontinuously lighting the portion of the interior light in the mode, based on an elapsed time since lighting of the portion, or the driver information, and
the controller controls a discontinuous change in the mode of the portion of the interior light when at least one of the direction or the risk of the obstacle is continuously changed.

2. The interior light control apparatus according to claim 1,
wherein a region in which the interior light is disposed includes a region corresponding to a blind spot of the driver.

3. The interior light control apparatus according to claim 1,
wherein the controller reduces the noticeability of the portion with passage of time.

4. The interior light control apparatus according to claim 3,
wherein the controller reduces the noticeability of the portion by reducing an area of the portion of the interior light with the passage of time.

5. The interior light control apparatus according to claim 3,
wherein the controller reduces the noticeability of the portion of the interior light by darkening the portion of the interior light with the passage of time.

6. The interior light control apparatus according to claim 1,
wherein when determining that the driver has confirmed the obstacle based on the driver information and the direction of the obstacle, the controller reduces the noticeability of the portion for the obstacle determined that the confirmation has been made.

7. The interior light control apparatus according to claim 6,
wherein after a lapse of a predefined time since lighting of the portion of the interior light, when determining that the driver does not confirm the obstacle, based on the driver information and the direction of the obstacle, the controller controls causing a notification device to notify the driver.

8. (canceled)

9. A method of controlling an interior light of a vehicle, the method comprising:
obtaining obstacle information that is information on an obstacle around the vehicle, and driver information that is information indicating a state of a driver;
determining a direction of the obstacle with respect to the driver of the vehicle and a risk of the obstacle, based on the obstacle information, and controlling lighting a portion corresponding to the direction with respect to the driver in an interior light, in a mode having noticeability for responding to the risk, the interior light being disposed to continuously or intermittently surround at least a front and a side of the driver in a top view;
controlling continuously or discontinuously lighting the portion of the interior light in the mode, based on an elapsed time since lighting of the portion, or the driver information; and
controlling a discontinuous change in the mode of the portion of the interior light when at least one of the direction or the risk of the obstacle is continuously changed.
